(19) United States
(12) Patent Application Publication
(10) Pub. No.: US 2017/0280754 A1
(43) Pub. Date: Oct. 5, 2017

(54) BUTTERED OATS PROCESS

(71) Applicant: Rani Bookvich, Ann Arbor, MI (US)

(72) Inventor: Rani Bookvich, Ann Arbor, MI (US)

(21) Appl. No.: 15/434,409

(22) Filed: Feb. 16, 2017

Related U.S. Application Data
(60) Provisional application No. 62/297,436, filed on Feb. 19, 2016.

(51) Int. Cl. A23L 7/122; A23L 7/196

(52) U.S. Cl. CPC A23L 7/122; A23L 7/1963; A23V 2002/00

(57) ABSTRACT

A buttered oats product can be created as a consumable product. The product can include oats and a butter and sugar sauce applied within a combined steam and convection oven at a temperature between 140 and 220 degrees Fahrenheit. Alternatively, a coconut oats product can be created as a consumable product. The product can include oats and a coconut oil and sugar sauce applied within a combined steam and convection oven at a temperature between 140 and 220 degrees Fahrenheit.

### CROSS REFERENCE TO RELATED APPLICATIONS

This disclosure claims the benefit of U.S. Provisional Application No. 62/297,436 filed on Feb. 19, 2016 which is hereby incorporated by reference.

### TECHNICAL FIELD

This disclosure is related to a process to create buttered oats for sale as a consumable product.

### BACKGROUND

The statements in this section merely provide background information related to the present disclosure. Accordingly, such statements are not intended to constitute an admission of prior art.

Granola is a breakfast cereal consisting of toasted rolled oats, brown sugar and honey with dried fruits and nuts on the outside. In the granola process heat is only used in the baking of the constituent parts. The sauce is not pre-heated. Ingredients such as oil and honey are mixed with dry oats at room temperature and heated. Toasted, cooked, and/or dried products (nutes, fruit, etc.) are combined with the oats as finished products.

### BRIEF DESCRIPTION OF THE DRAWINGS

One or more embodiments will now be described, by way of example, with reference to the accompanying drawings, in which:

FIG. 1 illustrates in a flow chart an exemplary process for preparing buttered oats, in accordance with the present disclosure;

FIG. 2 graphically illustrates the information of table 2, in accordance with the present disclosure;

FIG. 3 is a photographic image of an exemplary Convotherm oven used to create the buttered oats, in accordance with the present disclosure;

FIG. 4 schematically illustrates operation of an exemplary combined convection/steamer oven, in accordance with the present disclosure; and

FIG. 5 illustrates exemplary details of operation of the oven of FIG. 4, in accordance with the present disclosure.

### DETAILED DESCRIPTION

Buttered oats are a food product. A process for creating buttered oats is provided. Buttered oats are rolled oats butter and sugar. They are similar to granola, except buttered oats are not toasted or just covered with sauce. Through our process we use heat—our oat flavor is infused through the oats, thereby creating a unique light crisp. The term buttered oats is provided for the product, although butter can be substituted with another ingredient such as coconut oil.

Three exemplary, non-limiting differences between the disclosed product and other food products are provided. First, the sauce applied to the product is pre-heated prior to being applied to the oats. Second, fruit flavors are infused in the sauce, with the fruit being boiled down within the sauce rather than being added separately later as dried fruit mixed in with the end product. Additional dried fruit can be added later optionally, but the product is unique for having infused, boiled down fruits within the sauce. Third, the disclosed product is dried out or dehydrated with low heat without toasting the product. Not toasting the product is important to the texture.

Two exemplary sauces are provided. One includes butter and sugar. In this example, the butter is added early in the cooking process with the oats, and the sugar can be added later. Another includes coconut oil and sugar. In this example, the coconut oil and sugar are combined early/at the time when the sauce is applied to avoid the sugar remaining crystallized. Alternatively to these two sauces, coconut oil can be used in combination with butter buds to make a hybrid sauce.

According to one exemplary process, the oats are heated and the sauce is applied within an exemplary Convotherm by Cleveland oven, which can be described as a combined convection/steamer oven. However, in the exemplary process, the steam of the oven is turned off or not connected. The disclosed product can be made in a normal oven and achieve a similar texture, although testing has found that preparing the product in the Convotherm oven with the steam turned on high with the fans of the device turned on high excels in drying the product out without toasting the product. This process in the

Convetherm oven results in an excellent 18 month shelf life that exceeds other tested methods while still providing the unique texture. Heating the oats in this type of oven works like a vacuum wicking away moisture from the product. It pulls all the added moisture out of the product making it shelf stable for 18 months and a unique crunch and texture.

The disclosed process works with coconut oil and butter. Other exemplary oils have not worked in the past and the sugar was not able to melt in the oil—it stayed crystallized.

What is happening is the temp of 140 to 220 is high enough to penetrate the sauce through the oats while keeping the oats intact. This process creates a texture that is not seen anywhere in the market place. It is a soft crispy bite. This is what comes from our unique process.

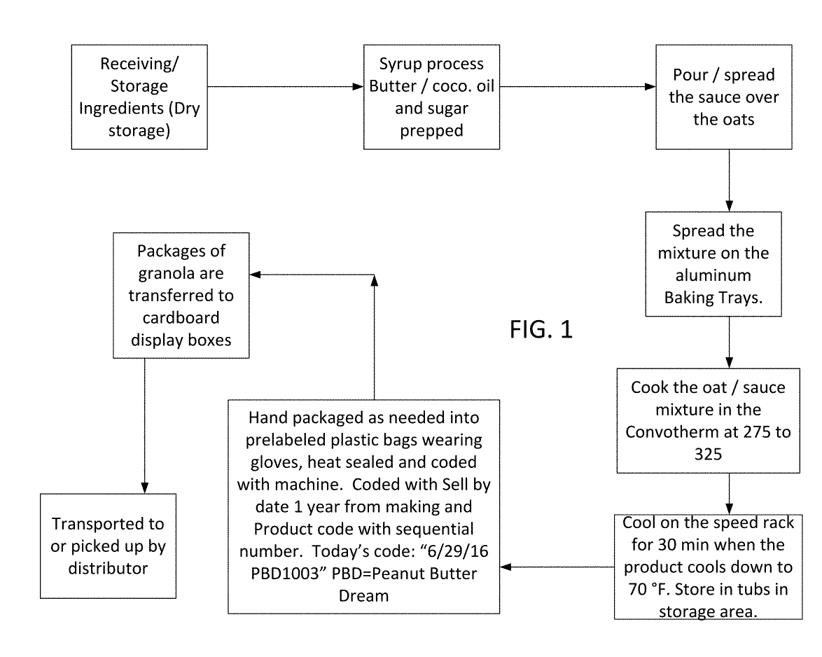

Referring now to the drawings, wherein the showings are for the purpose of illustrating certain exemplary embodiments only and not for the purpose of limiting the same, FIG. 1 illustrates in a flow chart an exemplary process for preparing buttered oats.

The following table illustrates exemplary ingredients of the butted oats product.

TABLE 1

| INGREDIENT | AMOUNT | | COMMENT |
|---|---|---|---|
| Oats | 4 | cups | |
| Butter | ¾ | cup | Either butter or coconut |
| | | | oil used - not both |
| Sugar | ¾ | cup | |
| Coconut oil | ¾ | cup | Either butter or coconut |
| | | | oil used - not both |

The following table illustrates a sampling of temperature readings of the Convotherm oven as two exemplary batches of buttered oats cooked sequentially are being prepared.

TABLE 2

| | | Fahrenheit | High | |
|---|---|---|---|---|
| patentTest16152 | Time | (° F.) | Alarm | Comments |
| 1 | Feb. 15, 2016 | 76 | 220 | |
| | 21:58 | | | |
| 2 | Feb. 15, 2016 | 70 | 220 | |
| | 21:58 | | | |
| 3 | Feb. 15, 2016 | 36.5 | 220 | |
| | 21:58 | | | |
| 4 | Feb. 15, 2016 | 85.5 | 220 | |
| | 21:58 | | | |
| 5 | Feb. 15, 2016 | 81 | 220 | Started |
| | 21:59 | | | Buttered |
| | | | | oats |
| 6 | Feb. 15, 2016 | 107.5 | 220 | |
| | 21:59 | | | |
| 7 | Feb. 15, 2016 | 60.5 | 220 | |
| | 21:59 | | | |
| 8 | Feb. 15, 2016 | 73 | 220 | |
| | 21:59 | | | |
| 9 | Feb. 15, 2016 | 75 | 220 | |
| | 21:59 | | | |
| 10 | Feb. 15, 2016 | 75.5 | 220 | |
| | 21:59 | | | |
| 11 | Feb. 15, 2016 | 156 | 220 | |
| | 22:00 | | | |
| 12 | Feb. 15, 2016 | 77.5 | 220 | |
| | 22:00 | | | |
| 13 | Feb. 15, 2016 | 77.5 | 220 | |
| | 22:00 | | | |
| 14 | Feb. 15, 2016 | 77.5 | 220 | |
| | 22:00 | | | |
| 15 | Feb. 15, 2016 | 77.5 | 220 | |
| | 22:00 | | | |
| 16 | Feb. 15, 2016 | 77.5 | 220 | |
| | 22:00 | | | |
| 17 | Feb. 15, 2016 | 77.5 | 220 | |
| | 22:01 | | | |
| 18 | Feb. 15, 2016 | 77.5 | 220 | |
| | 22:01 | | | |
| 19 | Feb. 15, 2016 | 78 | 220 | |
| | 22:01 | | | |
| 20 | Feb. 15, 2016 | 78 | 220 | |
| | 22:01 | | | |
| 21 | Feb. 15, 2016 | 78 | 220 | |
| | 22:01 | | | |
| 22 | Feb. 15, 2016 | 78 | 220 | |
| | 22:01 | | | |
| 23 | Feb. 15, 2016 | 78 | 220 | |
| | 22:02 | | | |
| 24 | Feb. 15, 2016 | 78 | 220 | |
| | 22:02 | | | |
| 25 | Feb. 15, 2016 | 78 | 220 | |
| | 22:02 | | | |
| 26 | Feb. 15, 2016 | 78 | 220 | |
| | 22:02 | | | |
| 27 | Feb. 15, 2016 | 119.5 | 220 | |
| | 22:02 | | | |
| 28 | Feb. 15, 2016 | 152.5 | 220 | |
| | 22:02 | | | |
| 29 | Feb. 15, 2016 | 152 | 220 | Surface temp |
| | 22:03 | | | 140 F. |
| 30 | Feb. 15, 2016 | 172.5 | 220 | |
| | 22:03 | | | |
| 31 | Feb. 15, 2016 | 176 | 220 | |
| | 22:03 | | | |
| 32 | Feb. 15, 2016 | 190.5 | 220 | |
| | 22:03 | | | |
| 33 | Feb. 15, 2016 | 178.5 | 220 | |
| | 22:03 | | | |
| 34 | Feb. 15, 2016 | 174 | 220 | |
| | 22:03 | | | |
| 35 | Feb. 15, 2016 | 207.5 | 220 | Sugar addd. |
| | 22:04 | | | Surface Temp |
| | | | | 160 F. |
| 36 | Feb. 15, 2016 | 176 | 220 | |
| | 22:04 | | | |
| 37 | Feb. 15, 2016 | 170.5 | 220 | |
| | 22:04 | | | |
| 38 | Feb. 15, 2016 | 176 | 220 | |
| | 22:04 | | | |
| 39 | Feb. 15, 2016 | 177.5 | 220 | |
| | 22:04 | | | |
| 40 | Feb. 15, 2016 | 169.5 | 220 | Surface Temp |
| | 22:04 | | | 150 F. |
| 41 | Feb. 15, 2016 | 171.5 | 220 | |
| | 22:05 | | | |
| 42 | Feb. 15, 2016 | 147 | 220 | |
| | 22:05 | | | |
| 43 | Feb. 15, 2016 | 137 | 220 | |
| | 22:05 | | | |
| 44 | Feb. 15, 2016 | 128.5 | 220 | |
| | 22:05 | | | |
| 45 | Feb. 15, 2016 | 132 | 220 | |
| | 22:05 | | | |
| 46 | Feb. 15, 2016 | 125.5 | 220 | |
| | 22:05 | | | |
| 47 | Feb. 15, 2016 | 150 | 220 | |
| | 22:06 | | | |
| 48 | Feb. 15, 2016 | 147 | 220 | Added butter to |
| | 22:06 | | | oats - End first |
| | | | | batch |
| 49 | Feb. 15, 2016 | 144 | 220 | |
| | 22:06 | | | |
| 50 | Feb. 15, 2016 | 130 | 220 | |
| | 22:06 | | | |
| 51 | Feb. 15, 2016 | 121.5 | 220 | |
| | 22:06 | | | |
| 52 | Feb. 15, 2016 | 117 | 220 | |
| | 22:06 | | | |
| 53 | Feb. 15, 2016 | 115.5 | 220 | |
| | 22:07 | | | |
| 54 | Feb. 15, 2016 | 117 | 220 | |
| | 22:07 | | | |
| 55 | Feb. 15, 2016 | 118.5 | 220 | |
| | 22:07 | | | |
| 56 | Feb. 15, 2016 | 119 | 220 | |
| | 22:07 | | | |
| 57 | Feb. 15, 2016 | 120 | 220 | |
| | 22:07 | | | |
| 58 | Feb. 15, 2016 | 120 | 220 | |
| | 22:07 | | | |
| 59 | Feb. 15, 2016 | 120.5 | 220 | |
| | 22:08 | | | |
| 60 | Feb. 15, 2016 | 120.5 | 220 | |
| | 22:08 | | | |
| 61 | Feb. 15, 2016 | 120 | 220 | |
| | 22:08 | | | |
| 62 | Feb. 15, 2016 | 120.5 | 220 | |
| | 22:08 | | | |
| 63 | Feb. 15, 2016 | 120.5 | 220 | |
| | 22:08 | | | |
| 64 | Feb. 15, 2016 | 120 | 220 | |
| | 22:08 | | | |
| 65 | Feb. 15, 2016 | 120.5 | 220 | |
| | 22:09 | | | |
| 66 | Feb. 15, 2016 | 120 | 220 | |
| | 22:09 | | | |
| 67 | Feb. 15, 2016 | 120 | 220 | |
| | 22:09 | | | |
| 68 | Feb. 15, 2016 | 119.5 | 220 | |
| | 22:09 | | | |
| 69 | Feb. 15, 2016 | 119.5 | 220 | |
| | 22:09 | | | |
| 70 | Feb. 15, 2016 | 119.5 | 220 | |
| | 22:09 | | | |
| 71 | Feb. 15, 2016 | 119.5 | 220 | |
| | 22:10 | | | |
| 72 | Feb. 15, 2016 | 119 | 220 | |
| | 22:10 | | | |
| 73 | Feb. 15, 2016 | 119 | 220 | |
| | 22:10 | | | |
| 74 | Feb. 15, 2016 | 119 | 220 | |
| | 22:10 | | | |
| 75 | Feb. 15, 2016 | 119 | 220 | |
| | 22:10 | | | |
| 76 | Feb. 15, 2016 | 119 | 220 | |
| | 22:10 | | | |
| 77 | Feb. 15, 2016 | 118.5 | 220 | |
| | 22:11 | | | |
| 78 | Feb. 15, 2016 | 118.5 | 220 | |
| | 22:11 | | | |
| 79 | Feb. 15, 2016 | 118.5 | 220 | |
| | 22:11 | | | |
| 80 | Feb. 15, 2016 | 118.5 | 220 | |
| | 22:11 | | | |
| 81 | Feb. 15, 2016 | 118 | 220 | |
| | 22:11 | | | |
| 82 | Feb. 15, 2016 | 118 | 220 | |
| | 22:11 | | | |
| 83 | Feb. 15, 2016 | 118 | 220 | |
| | 22:12 | | | |
| 84 | Feb. 15, 2016 | 118 | 220 | |
| | 22:12 | | | |
| 85 | Feb. 15, 2016 | 117.5 | 220 | |
| | 22:12 | | | |
| 86 | Feb. 15, 2016 | 117.5 | 220 | |
| | 22:12 | | | |
| 87 | Feb. 15, 2016 | 117.5 | 220 | |
| | 22:12 | | | |
| 88 | Feb. 15, 2016 | 117.5 | 220 | |
| | 22:12 | | | |
| 89 | Feb. 15, 2016 | 117 | 220 | |
| | 22:13 | | | |
| 90 | Feb. 15, 2016 | 114 | 220 | |
| | 22:13 | | | |
| 91 | Feb. 15, 2016 | 85 | 220 | |
| | 22:13 | | | |
| 92 | Feb. 15, 2016 | 80 | 220 | |
| | 22:13 | | | |
| 93 | Feb. 15, 2016 | 75 | 220 | |
| | 22:13 | | | |
| 94 | Feb. 15, 2016 | 71.5 | 220 | |
| | 22:13 | | | |
| 95 | Feb. 15, 2016 | 68.5 | 220 | |
| | 22:14 | | | |
| 96 | Feb. 15, 2016 | 67 | 220 | |
| | 22:14 | | | |
| 97 | Feb. 15, 2016 | 65.5 | 220 | |
| | 22:14 | | | |
| 98 | Feb. 15, 2016 | 69.5 | 220 | Started |
| | 22:14 | | | Coconut - |
| | | | | placed second |
| | | | | batch in oven |
| 99 | Feb. 15, 2016 | 87.5 | 220 | |
| | 22:14 | | | |
| 100 | Feb. 15, 2016 | 105 | 220 | Added Sugar |
| | 22:14 | | | |
| 101 | Feb. 15, 2016 | 102 | 220 | |
| | 22:15 | | | |
| 102 | Feb. 15, 2016 | 102 | 220 | |
| | 22:15 | | | |
| 103 | Feb. 15, 2016 | 112 | 220 | |
| | 22:15 | | | |
| 104 | Feb. 15, 2016 | 119 | 220 | |
| | 22:15 | | | |
| 105 | Feb. 15, 2016 | 126 | 220 | |
| | 22:15 | | | |
| 106 | Feb. 15, 2016 | 132.5 | 220 | |
| | 22:15 | | | |
| 107 | Feb. 15, 2016 | 134 | 220 | |
| | 22:16 | | | |
| 108 | Feb. 15, 2016 | 138 | 220 | |
| | 22:16 | | | |
| 109 | Feb. 15, 2016 | 146.5 | 220 | |
| | 22:16 | | | |
| 110 | Feb. 15, 2016 | 150.5 | 220 | |
| | 22:16 | | | |
| 111 | Feb. 15, 2016 | 148 | 220 | |
| | 22:16 | | | |
| 112 | Feb. 15, 2016 | 137.5 | 220 | Oats added |
| | 22:16 | | | |
| 113 | Feb. 15, 2016 | 128 | 220 | |
| | 22:17 | | | |
| 114 | Feb. 15, 2016 | 119 | 220 | |
| | 22:17 | | | |
| 115 | Feb. 15, 2016 | 118 | 220 | |
| | 22:17 | | | |
| 116 | Feb. 15, 2016 | 114 | 220 | |
| | 22:17 | | | |
| 117 | Feb. 15, 2016 | 114 | 220 | |
| | 22:17 | | | |
| 118 | Feb. 15, 2016 | 115 | 220 | |
| | 22:17 | | | |
| 119 | Feb. 15, 2016 | 112.5 | 220 | |
| | 22:18 | | | |
| 120 | Feb. 15, 2016 | 109 | 220 | |
| | 22:18 | | | |
| 121 | Feb. 15, 2016 | 106.5 | 220 | |
| | 22:18 | | | |
| 122 | Feb. 15, 2016 | 103.5 | 220 | |
| | 22:18 | | | |
| 123 | Feb. 15, 2016 | 101 | 220 | |
| | 22:18 | | | |
| 124 | Feb. 15, 2016 | 98 | 220 | |
| | 22:18 | | | |
| 125 | Feb. 15, 2016 | 97 | 220 | |
| | 22:19 | | | |
| 126 | Feb. 15, 2016 | 95.5 | 220 | |
| | 22:19 | | | |
| 127 | Feb. 15, 2016 | 94.5 | 220 | |
| | 22:19 | | | |
| 128 | Feb. 15, 2016 | 93.5 | 220 | |
| | 22:19 | | | |
| 129 | Feb. 15, 2016 | 92.5 | 220 | |
| | 22:19 | | | |
| 130 | Feb. 15, 2016 | 92 | 220 | |
| | 22:19 | | | |
| 131 | Feb. 15, 2016 | 91.5 | 220 | |
| | 22:20 | | | |
| 132 | Feb. 15, 2016 | 90.5 | 220 | |
| | 22:20 | | | |
| 133 | Feb. 15, 2016 | 89.5 | 220 | |
| | 22:20 | | | |
| 134 | Feb. 15, 2016 | 89 | 220 | |
| | 22:20 | | | |
| 135 | Feb. 15, 2016 | 88.5 | 220 | |
| | 22:20 | | | |
| 136 | Feb. 15, 2016 | 88 | 220 | |
| | 22:20 | | | |
| 137 | Feb. 15, 2016 | 87.5 | 220 | |
| | 22:21 | | | |
| 138 | Feb. 15, 2016 | 86.5 | 220 | |
| | 22:21 | | | |
| 139 | Feb. 15, 2016 | 86 | 220 | |
| | 22:21 | | | |
| 140 | Feb. 15, 2016 | 86 | 220 | |
| | 22:21 | | | |
| 141 | Feb. 15, 2016 | 85.5 | 220 | |
| | 22:21 | | | |
| 142 | Feb. 15, 2016 | 84 | 220 | |
| | 22:21 | | | |
| 143 | Feb. 15, 2016 | 83 | 220 | |
| | 22:22 | | | |
| 144 | Feb. 15, 2016 | 82.5 | 220 | |
| | 22:22 | | | |
| 145 | Feb. 15, 2016 | 89.5 | 220 | |
| | 22:22 | | | |
| 146 | Feb. 15, 2016 | 77.5 | 220 | |
| | 22:22 | | | |

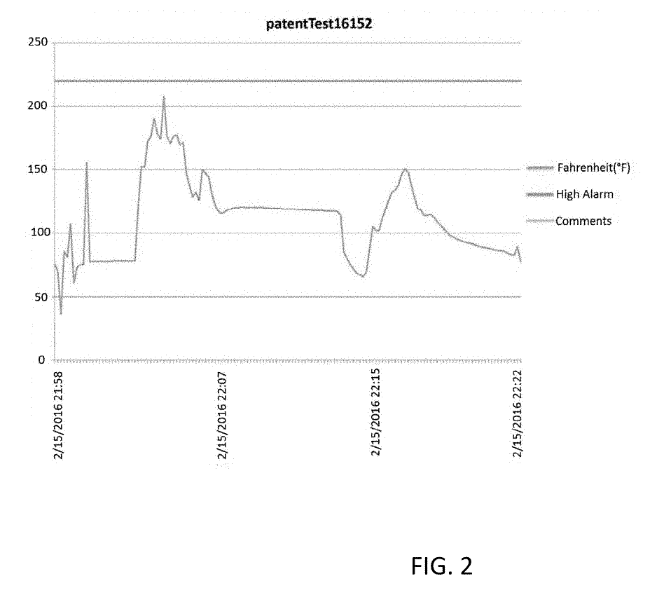

FIG. 2 graphically illustrates the information of table 2. Butter and sugar for the buttered oats and for the coconut oats it is oats coconut oil and sugar. It will be appreciated that other spices and flavorings can be added without changing the overall process significantly.

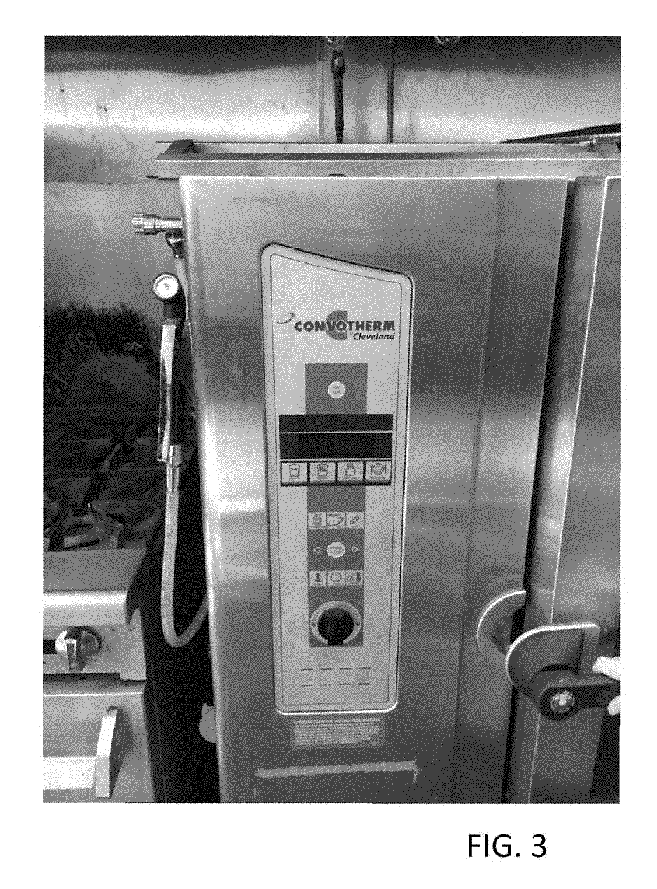

FIG. 3 is a photographic image of an exemplary Convotherm oven used to create the buttered oats.

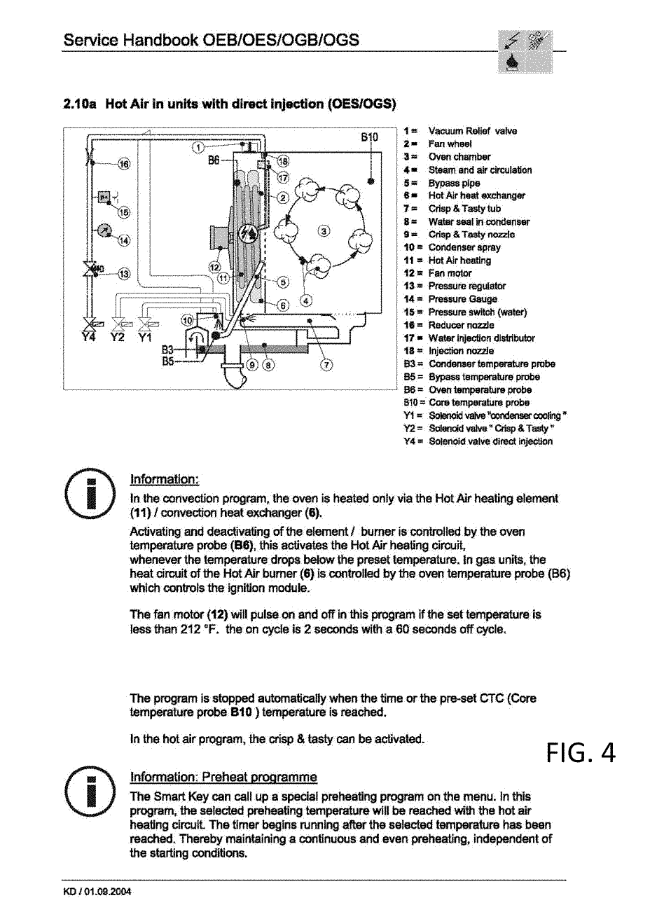

FIG. 4 schematically illustrates operation of an exemplary combined convection/steamer oven.

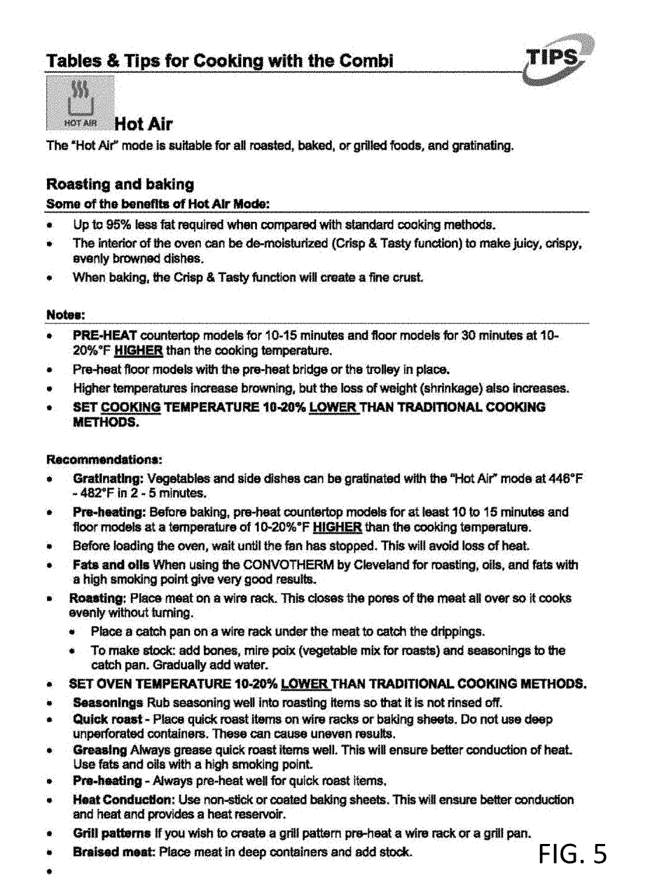

FIG. 5 illustrates exemplary details of operation of the oven of FIG. 4.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims. CLAIMS

1. A buttered oats product as a consumable product, the product comprising:
oats; and
a butter and sugar sauce applied within a combined steam and convection oven at a temperature between 140 and 220 degrees Fahrenheit.

2. A coconut oats product as a consumable product, the product comprising:
oats; and
a coconut oil and sugar sauce applied within a combined steam and convection oven at a temperature between 140 and 220 degrees Fahrenheit.
